(19) United States
(12) Patent Application Publication
(10) Pub. No.: US 2026/0094773 A1
(43) Pub. Date: Apr. 2, 2026

(54) CONTACTOR MOVABLE CONTACT ASSEMBLY AND CONTACTOR

(71) Applicant: Tyco Electronics Technology (SIP) Co., Ltd., Suzhou (CN)

(72) Inventors: Lulu (Steven) Zhou, Suzhou (CN); Zesheng Jiang, Suzhou (CN); Kevin (Xujia) Wang, Suzhou (CN); Quarry (Bingfeng) Qu, Suzhou (CN); Wenpei Qin, Suzhou (CN)

(73) Assignee: Tyco Electronics Technology (SIP) Co., Ltd., Suzhou (CN)

(21) Appl. No.: 19/343,693

(22) Filed: Sep. 29, 2025

(30) Foreign Application Priority Data
Sep. 29, 2024 (CN) 202411376044.4

(51) Int. Cl. H01H 1/50; H01H 1/22; H01H 50/58; H01H 50/64

(52) U.S. Cl. CPC H01H 1/502; H01H 1/221; H01H 50/58; H01H 50/641

(57) ABSTRACT

A contactor movable contact assembly includes an insulation seat, a drive shaft, a limit bracket, a movable contact and a springs. The drive shaft is located below the insulation seat and fixed to the insulation seat. The limit bracket is located above the insulation seat and is fixed to the insulation seat. The movable contact is installed in the limit bracket in a movable manner and can be moved in a vertical direction relative to the limit bracket. The spring is installed in the limit bracket and is axially compressed between the movable contact and the insulation seat. The insulation seat has an auxiliary contact pushing part, which is used to drive the auxiliary contact of the contactor to switch from the open state to the closed state or from the closed state to the open state.

### CROSS-REFERENCE TO RELATED APPLICATION

This application claims the benefit of Chinese Patent Application No. CN202411376044.4 filed on Sep. 29, 2024, in the State Intellectual Property Office of China, the whole disclosure of which is incorporated herein by reference.

### FIELD OF THE DISCLOSURE

The disclosure relates to a contactor movable contact assembly and a contactor comprising the contactor movable contact assembly.

### BACKGROUND OF THE INVENTION

In the prior art, a contactor typically includes a housing, a pair of static contacts, a movable contact assembly, an electromagnetic drive assembly, an auxiliary contact, and an auxiliary contact pushing member. An arc extinguishing chamber is formed in the housing. A pair of static contacts are fixed to the housing. The movable contact assembly is set in the arc extinguishing chamber of the housing in a movable manner. The electromagnetic drive assembly is installed in the housing to drive the movable contact assembly to move. The auxiliary contact is installed in the arc extinguishing chamber of the housing, and the auxiliary contact pushing member is installed on the movable contact assembly to move together with the movable contact assembly. Existing contactors require a separate auxiliary contact pushing member, which needs to be installed on the movable contact assembly. This leads to a contactor having a complex structure and a high cost.

In the prior art, the movable contact assembly usually includes an insulation seat, a drive shaft, a limit bracket, a movable contact, and a spring. The drive shaft and limit bracket are fixed to the insulation seat, and the movable contact is movable in the limit bracket. The spring is compressed between the movable contact and the insulation seat to apply contact pressure to the movable contact. There are positioning protrusions formed on the bottom surface of the movable contact and the top surface of the insulation seat for positioning the two ends of the spring. In the prior art, the spring can only be installed into the limit bracket horizontally from the side opening of the limit bracket. In order to avoid the positioning protrusion radially, the spring must be excessively compressed, which poses a risk of damage to the spring. Moreover, both ends of the spring use positioning protrusions for positioning, which is unreliable and poses a risk of excessive radial displacement of the spring.

### SUMMARY OF THE INVENTION

According to an embodiment of the present disclosure, a contactor movable contact assembly includes an insulation seat, a drive shaft, a limit bracket, a movable contact and a springs. The drive shaft is located below the insulation seat and fixed to the insulation seat. The limit bracket is located above the insulation seat and is fixed to the insulation seat. The movable contact is installed in the limit bracket in a movable manner and can be moved in a vertical direction relative to the limit bracket. The spring is installed in the limit bracket and is axially compressed between the movable contact and the insulation seat. The insulation seat has an auxiliary contact pushing part, which is used to drive the auxiliary contact of the contactor to switch from the open state to the closed state or from the closed state to the open state.

### DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative perspective view of a contactor movable contact assembly according to an exemplary embodiment of the present invention;

FIG. 2 shows a cross-sectional view along the first horizontal direction of a contactor movable contact assembly according to an exemplary embodiment of the present invention;

FIG. 3 shows a cross-sectional view along the second horizontal direction of a contactor movable contact assembly according to an exemplary embodiment of the present invention;

FIG. 4 shows a plan sectional view of a contactor movable contact assembly according to an exemplary embodiment of the present invention;

FIG. 5 shows an illustrative assembly view of a contactor movable contact assembly according to an exemplary embodiment of the present invention; and

FIG. 6 shows another illustrative assembly view of the contactor movable contact assembly according to an exemplary embodiment of the present invention.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a contactor movable contact assembly comprises: an insulation seat; a drive shaft located below the insulation seat and fixed to the insulation seat; a limit bracket located above the insulation seat and fixed to the insulation seat; a movable contact which is installed in the limit bracket in a movable manner and can be moved in a vertical direction relative to the limit bracket; and a spring which is installed in the limit bracket and axially compressed between the movable contact and the insulation seat. The insulation seat has an auxiliary contact pushing part, which is used to drive the auxiliary contact of the contactor to switch from the open state to the closed state or from the closed state to the open state.

According to another embodiment, a contactor comprises: a housing which is formed with an arc extinguishing chamber; a pair of static contacts fixed to the housing and having static contact points located in the arc extinguishing chamber; and the above contactor movable contact assembly, which is movable and arranged in the arc extinguishing chamber. The movable contact is adapted to move from an open position electrically separated from the static contact to a closed position in electrical contact with the static contact under the drive of the drive shaft.

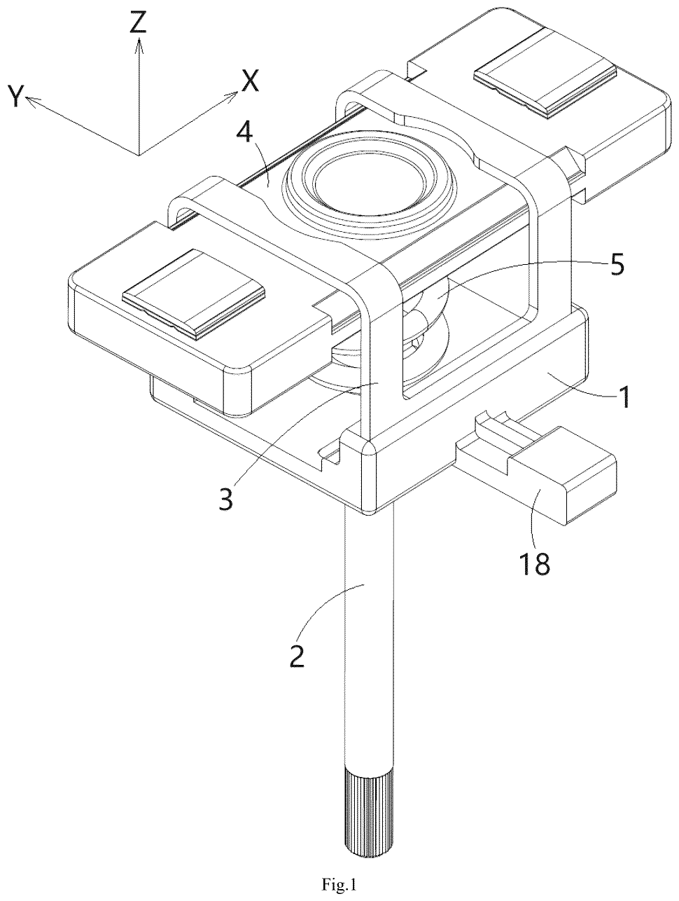

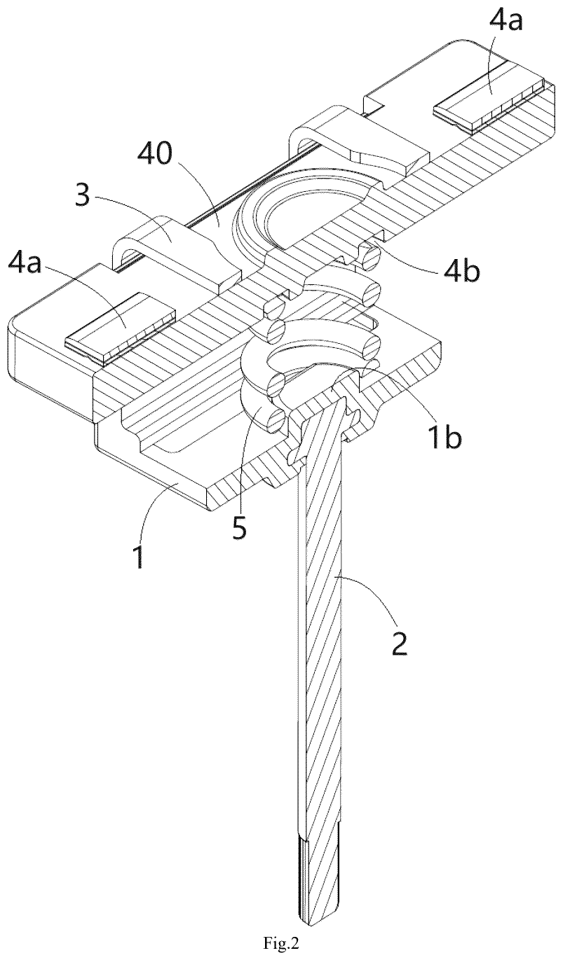

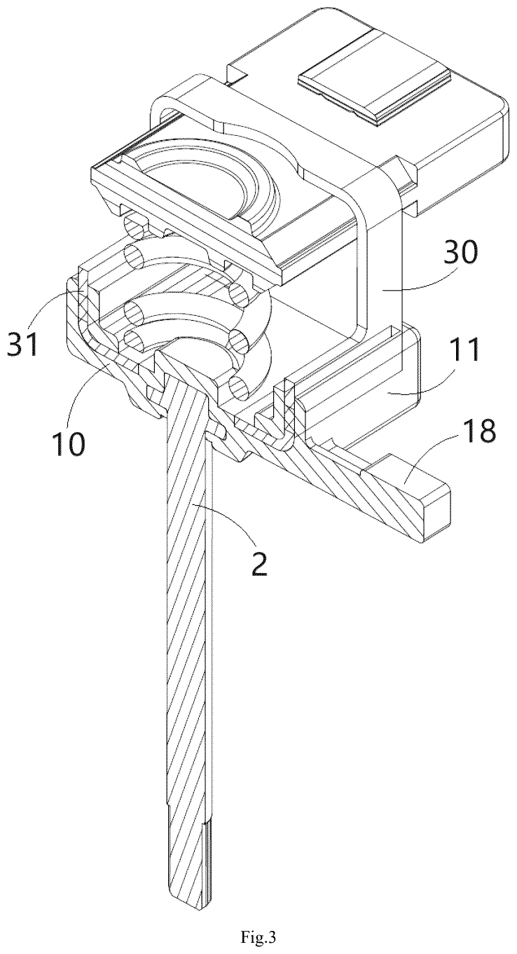

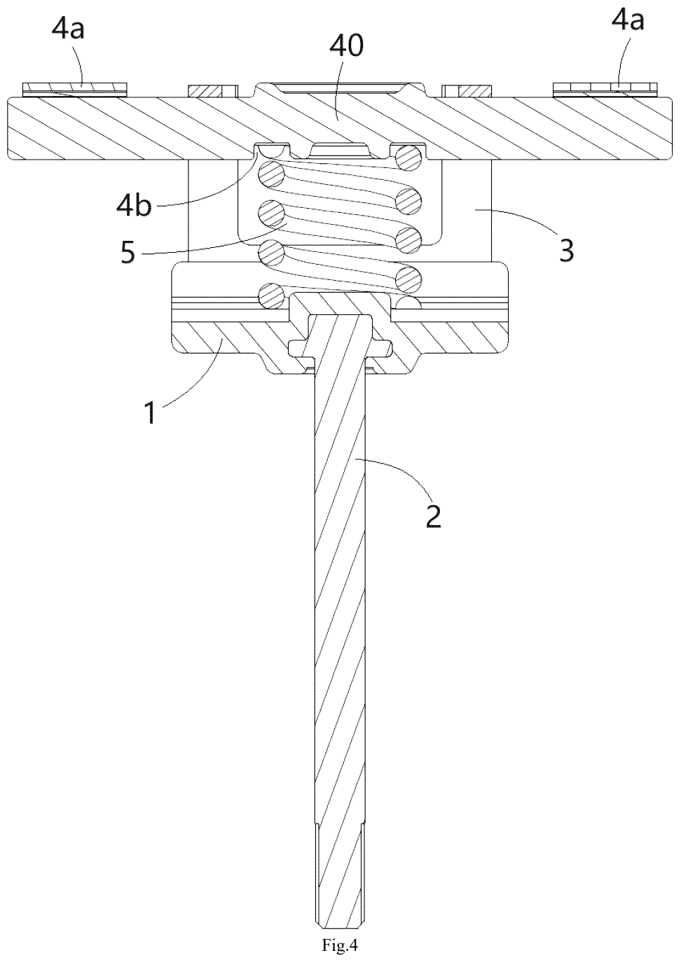

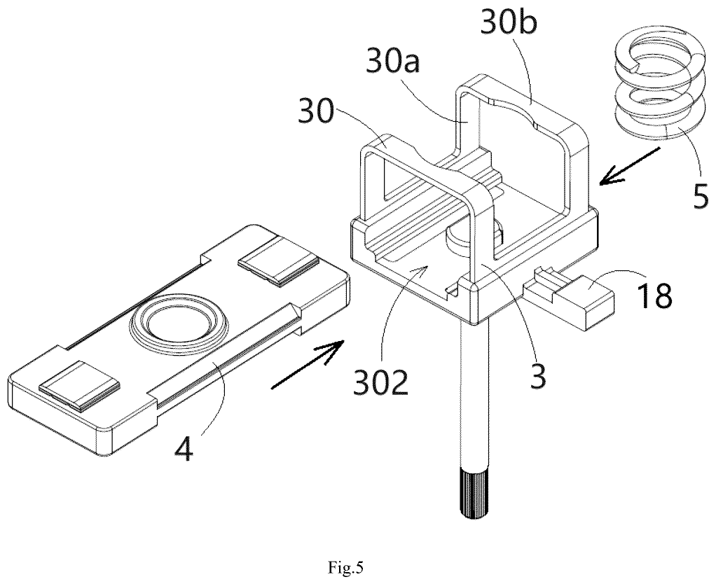

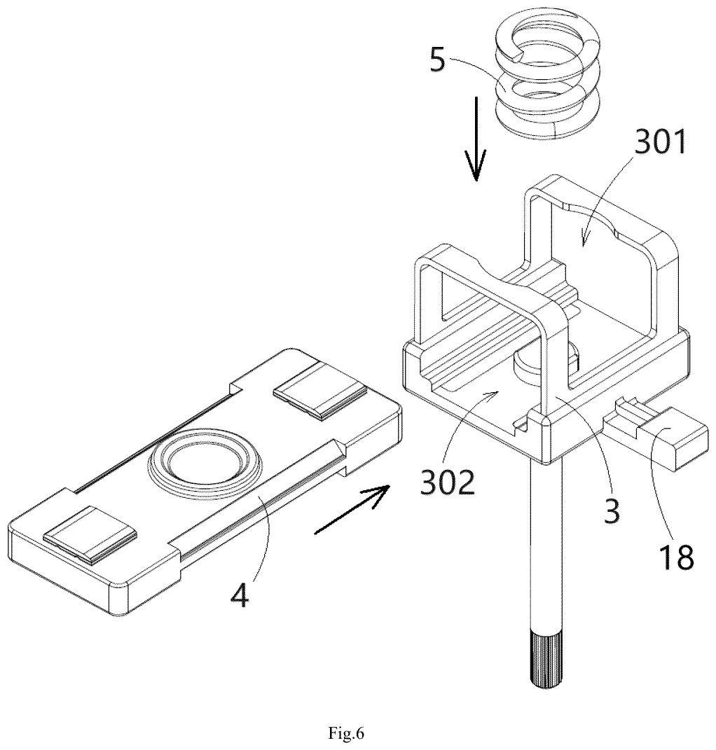

FIG. 1 shows an illustrative perspective view of a contactor movable contact assembly according to an exemplary embodiment of the present invention. FIG. 2 shows a cross-sectional view along the first horizontal direction X of a contactor movable contact assembly according to an exemplary embodiment of the present invention. FIG. 3 shows a cross-sectional view along the second horizontal direction Y of a contactor movable contact assembly according to an exemplary embodiment of the present invention. FIG. 4 shows a plan sectional view of a contactor movable contact assembly according to an exemplary embodiment of the present invention. FIG. 5 shows an illustrative assembly view of a contactor movable contact assembly according to an exemplary embodiment of the present invention. FIG. 6 shows another illustrative assembly view of the contactor movable contact assembly according to an exemplary embodiment of the present invention.

As shown in FIGS. 1-6, in an exemplary embodiment of the present disclosure, a contactor movable contact assembly is provided. The contactor movable contact assembly includes: an insulation seat 1, a drive shaft 2, a limit bracket 3, a movable contact 4, and a spring 5. The drive shaft 2 is located below insulation seat 1 and is fixed to insulation seat 1. The limit bracket 3 is located above insulation seat 1 and is fixed to insulation seat 1. The movable contact 4 is installed in the limit bracket 3 in a movable manner and can be moved in the vertical direction Z relative to the limit bracket 3. The spring 5 is installed in the limit bracket 3 and compressed axially between the movable contact 4 and the insulation seat 1. The spring 5 is used to apply a predetermined contact pressure to the movable contact 4 to ensure reliable electrical contact between the movable contact 4 and the contact point (not shown) of the contactor. In the illustrated embodiment, the insulation seat 1 is integrated with an auxiliary contact pushing part 18, which is used to drive the auxiliary contact (not shown) of the contactor to switch from the open state to the closed state or from the closed state to the open state.

The limit bracket 3 has a top opening 301 and a pair of opposite side openings 302 in the first horizontal direction X. The movable contact 4 is adapted to be inserted into the limit bracket 3 from the side opening 302 of the limit bracket 3. The spring 5 is adapted to be inserted into the limit bracket 3 from the top opening 301 or side opening 302 of the limit bracket 3.

The movable contact 4 includes a main body 40 and a pair of movable contact points 4a. The pair of movable contact points 4a are respectively formed on the top surfaces of both ends of the main body 40. The pair of movable contact points 4a are used to make electrical contact with the static contact points (not shown) of a pair of static contacts of the contactor. A circular positioning groove 4b is formed on the bottom surface of the main body 40 of the movable contact 4, and the upper end of the spring 5 is accommodated and positioned in the positioning groove 4b of the main body 40 of the movable contact 4.

A positioning protrusion 1b is formed in the insulation seat 1. The positioning protrusion 1b is inserted into the lower end of the spring 5 for positioning the lower end of the spring 5. The positioning groove 4b and the positioning protrusion 1b are spaced opposite and coaxial in the axial direction of the spring 5 to prevent radial displacement of the spring 5.

The bottom of the limit bracket 3 and the upper end of the drive shaft 2 are embedded into the insulation seat 1. In this way, the insulation seat 1 electrically isolates the drive shaft 2 from the limit bracket 3 and the spring 5. In the illustrated embodiment, the insulation seat 1 is an injection molded part that is injected onto the bottom of the limit bracket 3 and the upper end of the drive shaft 2, making the insulation seat 1, limit bracket 3, and drive shaft 2 an integral piece.

The insulation seat 1 includes a bottom wall 10 and a pair of side walls 11, which are spaced apart and opposed in a second horizontal direction Y perpendicular to the first horizontal direction X. The positioning protrusion 1b is formed on the top surface of the bottom wall 10 of the insulation seat 1. The auxiliary contact pushing part 18 is formed on the outer side of one side wall 11 of the insulation seat 1. The upper end of the drive shaft 2 is embedded into the bottom wall 10 of the insulation seat 1, and the bottom of the limit bracket 3 is embedded into the pair of side walls 11 and the bottom wall 10 of the insulation seat 1.

The limit bracket 3 includes a pair of limiting parts 30 and a pair of fixing parts 31. The pair of limiting parts 30 are spaced opposite each other in the first horizontal direction X. The pair of fixing parts 31 are embedded into the pair of side walls 11 and the bottom wall 10 of the insulation seat 1. The limiting part 30 is in an inverted U-shape, with one ends of the pair of limiting parts 30 connected to the upper side of one fixing part 31, and the other ends connected to the upper side of the other fixing part 31. The top opening 301 of the limit bracket 3 is located between the pair of limiting parts 30, and the pair of limiting parts 30 respectively define the pair of side openings 302 of the limit bracket 3.

The limiting part 30 includes a pair of vertical arms 30a and a horizontal arm 30b. The pair of vertical arms 30a extend along the vertical direction Z. The horizontal arm 30b is connected between the upper ends of the pair of vertical arms 30a. The lower ends of the pair of vertical arms 30a are respectively connected to the upper sides of the pair of fixing parts 31.

In the illustrated embodiment, the horizontal arm 30b of the limiting part 30 is pressed against the top surface of the main body 40 of the movable contact 4, and the pair of vertical arms 30a of the limiting part 30 are respectively located on both sides of the main body 40 of the movable contact 4. The two ends of the main body 40 of the movable contact 4 extend from the limit bracket 3. In this way, it can be ensured that the pair of movable contact points 4a are located outside the limit bracket 3.

As shown in FIGS. 1-6, in another exemplary embodiment of the present disclosure, a contactor is also disclosed. The contactor includes a housing (not shown), a pair of static contacts (not shown), and the aforementioned contactor movable contact assembly. An arc extinguishing chamber is formed in the housing. The pair of static contacts are fixed to the housing and have static contact points located in the arc extinguishing chamber. The contactor movable contact assembly is arranged in a movable manner in the arc extinguishing chamber. The movable contact 4 is suitable for moving from the open position electrically separated from the static contact to the closed position electrically in contact with the static contact under the drive of the drive shaft 2.

In the illustrated embodiment, the contactor further comprises an auxiliary contact, which is installed in the arc extinguishing chamber of the housing and can be switched between open and closed states. When the movable contact 4 is moved from the open position to the closed position, the auxiliary contact is switched from the open state to the closed state or from the closed state to the open state by the driving of the auxiliary contact pushing part 18. Therefore, it is possible to accurately determine whether the movable contact is in the closed position or the open position based on the status of the auxiliary contact.

The contactor further comprises an electromagnetic drive assembly (not shown), which is installed in the housing for generating electromagnetic driving force. Drive shaft 2 is suitable for axial movement under the action of electromagnetic driving force generated by the electromagnetic drive assembly, to drive the movable contact 4 to move between the open position and the closed position. Electromagnetic drive assembly typically includes a coil frame, a coil wound on the coil frame, a magnetic core inserted into the coil frame, a yoke, and a magnetic plate fixed to the coil frame. The magnetic core, yoke, and magnetic plate form a magnetic circuit.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A contactor movable contact assembly, comprising:
an insulation seat including an auxiliary contact pushing part adapted to drive an auxiliary contact of a contactor to switch from an open state to a closed state or from the closed state to the open state;
a drive shaft arranged below the insulation seat and fixed to the insulation seat;
a limit bracket arranged above the insulation seat and fixed to the insulation seat;
a movable contact installed in the limit bracket in a movable manner and movable in a vertical direction relative to the limit bracket; and
a spring installed in the limit bracket and axially compressed between the movable contact and the insulation seat.

2. The contactor movable contact assembly according to claim 1, wherein the limit bracket has a top opening and a pair of opposite side openings in a first horizontal direction, the movable contact is adapted to be inserted into the limit bracket from the side opening of the limit bracket, and the spring is adapted to be inserted into the limit bracket from the top opening or side opening of the limit bracket.

3. The contactor movable contact assembly according to claim 1, wherein the movable contact comprises:
a main body; and
a pair of movable contact points respectively formed on top surfaces of both ends of the main body, the pair of movable contact points are adapted to make electrical contact with static contact points of a pair of static contacts of the contactor.

4. The contactor movable contact assembly according to claim 3, wherein a circular positioning groove is formed on a bottom surface of the main body of the movable contact, and an upper end of the spring is accommodated and positioned in the positioning groove of the main body of the movable contact.

5. The contactor movable contact assembly according to claim 4, wherein a positioning protrusion is formed in the insulation seat and is inserted into a lower end of the spring for positioning the lower end of the spring.

6. The contactor movable contact assembly according to claim 5, wherein the positioning groove and the positioning protrusion are spaced opposite and coaxial in an axial direction of the spring to prevent radial displacement of the spring.

7. The contactor movable contact assembly according to claim 6, wherein a bottom of the limit bracket and an upper end of the drive shaft are embedded into the insulation seat, and the insulation seat electrically isolates the drive shaft from the limit bracket and the spring.

8. The contactor movable contact assembly according to claim 7, wherein the insulation seat is an injection molded part on the bottom of the limit bracket and the upper end of the drive shaft, making the insulation seat, the limit bracket, and the drive shaft an integral piece.

9. The contactor movable contact assembly according to claim 5, wherein the insulation seat comprises a bottom wall and a pair of side walls, wherein the pair of side walls are spaced apart and opposed in a second horizontal direction perpendicular to the first horizontal direction.

10. The contactor movable contact assembly according to claim 9, wherein the positioning protrusion is formed on a top surface of the bottom wall of the insulation seat, and the auxiliary contact pushing part is formed on the outer side of one side wall of the insulation seat.

11. The contactor movable contact assembly according to claim 7, wherein the upper end of the drive shaft is embedded into a bottom wall of the insulation seat, and the bottom of the limit bracket is embedded into a pair of side walls and the bottom wall of the insulation seat.

12. The contactor movable contact assembly according to claim 8, wherein the limit bracket comprises:
a pair of limiting parts spaced opposite each other in the first horizontal direction; and
a pair of fixing parts embedded into a pair of side walls and the bottom wall of the insulation seat.

13. The contactor movable contact assembly according to claim 12, wherein the limiting part is in an inverted U-shape, with one ends of the pair of limiting parts connected to an upper side of one fixing part and the other ends connected to an upper side of the other fixing part.

14. The contactor movable contact assembly according to claim 13, wherein a top opening of the limit bracket is located between the pair of limiting parts, and the pair of limiting parts respectively define a pair of side openings of the limit bracket.

15. The contactor movable contact assembly according to claim 13, wherein the limiting part comprises:
a pair of vertical arms extending along the vertical direction; and
a horizontal arm connected between upper ends of the pair of vertical arms, lower ends of the pair of vertical arms are respectively connected to the upper sides of the pair of fixing parts.

16. The contactor movable contact assembly according to claim 15, wherein the horizontal arm of the limiting part is pressed against a top surface of the main body of the movable contact, and the pair of vertical arms of the limiting part are respectively located on both sides of the main body of the movable contact, the two ends of the main body of the movable contact extend from the limit bracket.

17. A contactor, comprising:
a housing formed with an arc extinguishing chamber;
a pair of static contacts fixed to the housing and having static contact points located in the arc extinguishing chamber; and
a contactor movable contact assembly movable and arranged in the arc extinguishing chamber, including:
an insulation seat including an auxiliary contact pushing part adapted to drive an auxiliary contact of the contactor to switch from an open state to a closed state or from the closed state to the open state;
a drive shaft arranged below the insulation seat and fixed to the insulation seat;
a limit bracket arranged above the insulation seat and fixed to the insulation seat;
a movable contact installed in the limit bracket in a movable manner and movable in a vertical direction relative to the limit bracket, the movable contact is adapted to move from an open position electrically separated from the static contact to a closed position in electrical contact with the static contact under the drive of the drive shaft; and
a spring installed in the limit bracket and axially compressed between the movable contact and the insulation seat.

18. The contactor according to claim 17, further comprising:
an auxiliary contact installed in the arc extinguishing chamber of the housing, capable of switching between open and closed states,
wherein when the movable contact is moved from the open position to the closed position, the auxiliary contact is switched from the open state to the closed state or from the closed state to the open state by the driving of the auxiliary contact pushing part.

19. The contactor according to claim 17, further comprising an electromagnetic drive assembly installed in the housing for generating electromagnetic driving force.

20. The contactor according to claim 19, wherein the driving shaft is adapted to move axially under the action of the electromagnetic driving force generated by the electromagnetic drive assembly to drive the movable contact to move between the open position and the closed position.
